(19) United States
(12) Patent Application Publication
(10) Pub. No.: US 2026/0241620 A1
(43) Pub. Date: Aug. 20, 2026

(54) REFRACTORY COMPOSITION AND MOLDED ARTICLE USING SAME

(71) Applicants: Hyundai Motor Company, Seoul (KR); Kia Corporation, Seoul (KR); HDC HYUNDAI ENGINEERING PLASTICS CO., LTD., Dangjin (KR)

(72) Inventors: Sang Soo Jeon, Hwaseong (KR); Seung Woo Choi, Hwaseong (KR); Eun Seob Shin, Yongin (KR); Kang Il Jeon, Yongin (KR); Dong Hwan Lee, Yongin (KR)

(21) Appl. No.: 19/292,592

(22) Filed: Aug. 6, 2025

(30) Foreign Application Priority Data
Feb. 18, 2025 (KR) 10-2025-0020668

(51) Int. Cl. B29C 45/00; B29K 61/00; B29K 77/00; B29K 105/00; B29K 105/16; B29K 483/00; B29K 505/02; B29K 509/08; B29L 31/00

(52) U.S. Cl. CPC B29C 45/0001; B29C 45/0005; B29K 2061/00; B29K 2077/00; B29K 2105/0026; B29K 2105/0067; B29K 2105/0088; B29K 2105/16; B29K 2483/00; B29K 2505/02; B29K 2509/08; B29L 2031/7146

(57) ABSTRACT

Provided is a refractory composition including from about 20 wt % to 55 wt % of a base resin including polyketone, a fibrous filler, a non-fibrous filler, and a flame retardant. The fibrous filler may have a length/diameter ratio of greater than 3. The composition can optionally contain additives such as antioxidants or processing stabilizers. Potential applications include heating devices, battery housings, and other high-temperature environments.

### CROSS-REFERENCE TO RELATED APPLICATION

This application claims, under 35 U.S.C. § 119 (a), the benefit of Korean Patent Application No. 10-2025-0020668, filed on Feb. 18, 2025, the entire contents of which are incorporated herein by reference.

### BACKGROUND

### Technical Field

The present disclosure relates to a refractory composition and a molded article using the same.

### Background

Recently, the spread of electric vehicles has increased significantly as an alternative to internal combustion engine vehicles. Research is ongoing on fire stability and the integration of cells or battery modules per unit battery pack area to increase the range and output of electric vehicles.

Battery cells within a battery pack may ignite due to factors such as manufacturing defects, external pressure, impact, and overcharging, which can result in heat transfer to adjacent battery cells or battery modules and cause thermal instability throughout the battery pack.

If such thermal instability occurs, the housing or structure enclosing the battery module may melt due to high temperatures of 1,000° C. or more, and thermal instability in adjacent battery modules may be further accelerated.

To prevent thermal instability in the battery pack, not only the safety design of the battery pack but also fire resistance and heat insulation performance of parts that make up the battery module and pack are considered critical.

Glass fiber-filled polypropylene resin and injection-molded articles using the same may be used for housings for battery modules and battery packs, but the structure and rigidity of the parts cannot be maintained in the event of thermal instability.

### SUMMARY OF THE DISCLOSURE

The present disclosure has been made keeping in mind the problems encountered in the related art and provides a composition capable of delaying the acceleration of thermal instability and imparting fire resistance when thermal instability occurs in a heating device, a battery pack, etc., and a molded article using the same.

The present disclosure also provide a composition having good durability after a Torch and Grit test at a temperature of about 1,200° C., maintaining structure and rigidity, and having insulating properties, and a molded article using the same.

The present disclosure will be able to be clearly understood through the following description and to be realized by the means described in the claims and combinations thereof.

Some embodiments of the present disclosure provides a refractory composition including 20 wt % to 55 wt % of a base resin including polyketone, a fibrous filler, a non-fibrous filler, and a flame retardant, in which the fibrous filler has a length/diameter ratio of greater than 3.

The refractory composition may be applied to a member of a heating device.

An amount of the fibrous filler may be from about 30 wt % to 60 wt % based on a total weight of the composition.

An amount of the non-fibrous filler may be from about 6 wt % to 15 wt % based on a total weight of the composition.

An amount of the flame retardant may be from about 4 wt % to 20 wt % based on a total weight of the composition.

The polyketone may have a melt flow rate of 150 g/10 min to 400 g/10 min at 240° C. under a load of 2.16 kg in accordance with ASTM D1238.

The fibrous filler may comprise at least one of glass fiber, carbon fiber, basalt fiber and quartz fiber.

The non-fibrous filler may comprise at least one of silica, silicone, alumina, silicon carbide, boron carbide, silicon nitride, zirconia, titania, magnesia, aluminosilicate, calcium silicate and talc.

The non-fibrous filler may comprise silica, silicone and alumina.

In aspects, an amount of the silica suitably may be from about 2 wt % to 5 wt %, an amount of the silicone is from about 2 wt % to 5 wt %, and an amount of the alumina is from about 2 wt % to 5 wt %, based on a total weight of the composition.

In aspects, the flame retardant suitably may comprise one or more phosphate agents such as at least one of triphenyl phosphate, trimethyl phosphate, triethyl phosphate, bisphenol diphenyl phosphate, ammonium polyphosphate, melamine polyphosphate, melamine pyrophosphate, melamine ammonium phosphate, melamine cyanurate, piperazine polyphosphate, xylenyl diphenyl phosphate, aluminum hydroxide and/or magnesium hydroxide.

In aspects, the refractory composition suitably may further comprise from about 0.5 wt % to 2 wt % of an additive based on a total weight of the composition, wherein the additive comprises at least one of an antioxidant, a processing stabilizer, or an activator.

N aspects, the base resin suitably may further comprise polyamide, and an amount of the polyketone is from about 16 wt % to 44 wt % and an amount of the polyamide is from about 4 wt % to 11 wt % based on a total weight of the composition.

The present disclosure may provide a molded article produced by molding the refractory composition described above.

The present disclosure may provide an energy storage device including a housing manufactured by melting and injection molding the refractory composition described above and at least one of a battery cell or a battery module disposed in the housing.

In some other embodiments, a refractory composition is provided, comprising: a base resin comprising polyketones in an amount from about 20 wt % to 55 wt %, said polyketones having a melt flow rate of 150 g/10 min to 400 g/10 min at 240° C. under a load of 2.16 kg in accordance with ASTM D1238; a fibrous filler in an amount from about 30 wt % to 60 wt %, said fibrous filler having a length-to-diameter ratio greater than 3; a non-fibrous filler in an amount from about 6 wt % to about 15 wt %; and a flame retardant in an amount from about 4 wt % to 20 wt %.

The refractory composition may further comprise one or more additives in a total amount from about 0.5 wt % to 2 wt %, wherein the one or more additives are selected from the group consisting of antioxidants, processing, stabilizers, and activators.

The non-fibrous filler may comprise silica, silicone, and alumina, each in an amount of from about 2 wt % to 5 wt %, based on a total weight of the composition.

The base resin may further comprise polyamide. An amount of the polyketone may be from about 16 wt % to 40 wt %, and an amount of the polyamide may be from about 4 wt % to 11 wt %, each based on the total weight of the composition.

### BRIEF DESCRIPTION OF THE DRAWING

FIG. 1 is a photograph showing results of the Torch and Grit test of Example 2.

FIG. 2 is a photograph showing results of the Torch and Grit test of Comparative Example 2, according to Test Example.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Herein, a comma “,” may be interpreted as “and” or “or” depending on the context, and if the elements listed through the comma end with “or”, the comma may be interpreted as “or”. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

The term “polyketone” herein refers to a polymer (or a copolymer) having a repeating ketone group (—CO—) in the main chain.

The term “energy storage device” herein refers to any apparatus or system that houses one or more battery cells or battery modules.

### Refractory Composition

A refractory composition according to some embodiments of the present disclosure may include 20 wt % to 55 wt % of a base resin including polyketone, a fibrous filler, a non-fibrous filler, and a flame retardant, in which the fibrous filler may have a length/diameter ratio of greater than 3.

The refractory composition may be applied to a member of a heating device and may be applied to a member of a heating device in which thermal instability may occur at 1,000° C. or higher. For example, the refractory composition may be applied to a member of a battery module or a battery pack, or to a housing.

The polyketone of the basic resin may be a homopolymer having substantially one repeat unit.

The polyketone may include a plurality of ketone groups and an alkylene connecting one ketone group and another ketone group, and the carbon number of alkylene may be C2 to C5.

The polyketone may have a melt flow rate of 150 g/10 min to 400 g/10 min, or 180 g/10 min to 350 g/10 min, at 240° C. under a load of 2.16 kg according to ASTM D1238. When the melt flow rate falls in the above range, the composition may be imparted with good extrusion and injection processability.

The composition may have a melt flow rate of 30 g/10 min to 90 g/10 min, or 46 g/10 min to 79 g/10 min, at 240° C. under a load of 2.16 kg according to ASTM D1238. When the melt flow rate falls in the above range, the composition may be imparted with good extrusion and injection processability.

The amount of the base resin may be 20 wt % to 55 wt %, or 25 wt % to 50 wt %, based on the total weight of the composition. If the amount of the basic resin is less than 20 wt %, refractory performance may deteriorate. In contrast, if the amount of the basic resin exceeds 55 wt %, the amount of the fillers may decrease, which may also deteriorate refractory performance.

The amount of the fibrous filler may be 30 wt % to 60 wt %, or 35 wt % to 55 wt %, based on the total weight of the composition. If the amount of the fibrous filler is less than 30 wt %, refractory performance may deteriorate, and it may be difficult to maintain the structure and rigidity after a Torch and Grit test. In contrast, if the amount of the fibrous filler exceeds 60 wt %, extrusion and injection processability may deteriorate, and appearance quality of the molded article may become poor.

The fibrous filler may have a shape with a constant cross-section and a predetermined length, an oval shape, a plate shape, etc., and the average size of the cross-section may correspond to the diameter. The fibrous filler may have a length/diameter ratio of greater than 3, and 10,000 or less, or 5,000 or less.

The fibrous filler may have an average diameter of 2 μm to 30 μm, or 5 μm to 20 μm. When the cross-section thereof falls in the above range, dispersibility may be improved and mechanical properties such as impact strength, etc. may be effectively supplemented.

The fibrous filler may include at least one of glass fiber, carbon fiber, basalt fiber, or quartz fiber, and may include, for example, glass fiber, or may be glass fiber.

The amount of the non-fibrous filler may be 6 wt % to 15 wt % based on the total weight of the composition. If the amount of the non-fibrous filler is less than 6 wt %, refractory performance may deteriorate. In contrast, if the amount of the non-fibrous filler exceeds 15 wt %, processability and appearance quality may deteriorate.

The non-fibrous filler may be partially in a liquid form, or, if solid, may have an aspect ratio of 3 or less and 1 or more. The aspect ratio may be defined as the ratio of the maximum length/the length perpendicular to the maximum length in the maximum cross-section of a solid material.

The non-fibrous filler may include, for example, at least one of silica, silicone, alumina, silicon carbide, boron carbide, silicon nitride, zirconia, titania, magnesia, aluminosilicate, calcium silicate, or talc, and preferably includes silica, silicone, and alumina.

The silica may include particles having a cristobalite structure among silica isotopes and may serve to further improve refractory performance.

The silicone may serve to improve flowability and processability of the resin and improve appearance quality of the molded article.

The aluminum and aluminosilicate have good thermal conductivity, so when the composition is applied to a member of a heating device, it may be sintered in the heating device that is thermally unstable and is able to form a stable structure.

In the non-fibrous filler, the solid material may have a particle size of 10 μm to 100 μm, or 20 μm to 50 μm. The alumina may include first alumina particles having a particle size of 15 μm to 25 μm and second alumina particles having a particle size of 35 μm to 45 μm.

When the non-fibrous filler includes silica, silicone, and alumina, the amount of the silica may be 2 wt % to 5 wt %, the amount of the silicone may be 2 wt % to 5 wt %, and the amount of the alumina may be 2 wt % to 5 wt %, based on the total weight of the composition. If the amount of the silica is less than 2 wt %, refractory performance may deteriorate. In contrast, if the amount of the silica exceeds 5 wt %, processability may deteriorate and appearance quality may become poor. If the amount of the silicone is less than 2 wt %, improvement in the flowability of the resin may be insignificant, and appearance quality of the molded article may become poor. In contrast, if the amount of the silicone exceeds 5 wt %, excessive gas generation may occur during molding, and gas generation may increase in a high-temperature environment. If the amount of the alumina is less than 2 wt %, sintering may not occur uniformly in a high-temperature environment, deteriorating refractory performance. In contrast, if the amount of the alumina exceeds 5 wt %, flowability and processability of the resin may deteriorate, resulting in poor appearance quality.

The flame retardant may be a non-halogen flame retardant substantially free of halogen element components.

The amount of the flame retardant may be 4 wt % to 20 wt %, or 5 wt % to 15 wt %. If the amount of the flame retardant is less than 4 wt %, flame retardancy may be insufficient. In contrast, if the amount of the flame retardant exceeds 20 wt %, during a refractory performance test, peeling of the carbonized material of the molded article may occur, the carbonized layer may expand and the degree of deformation may be excessive, and it may be difficult to maintain the structure and rigidity.

The flame retardant may include, for example, at least one of triphenyl phosphate, trimethyl phosphate, triethyl phosphate, bisphenol diphenyl phosphate, ammonium polyphosphate, melamine polyphosphate, melamine pyrophosphate, melamine ammonium phosphate, melamine cyanurate, piperazine polyphosphate, xylenyl diphenyl phosphate, aluminum hydroxide, or magnesium hydroxide.

The base resin may further include polyamide in addition to the polyketone. The polyamide may include at least one of polyamide 6, polyamide 66, or a polyamide 6/66 copolymer.

When the base resin further includes polyamide, the amount of the polyketone may be 16 wt % to 44 wt % and the amount of the polyamide may be 4 wt % to 11 wt %, based on the total weight of the composition. Particularly, the amount of the polyketone may be 20 wt % to 40 wt %, and the amount of the polyamide may be 5 wt % to 10 wt %. If the amount of the polyamide is less than 4 wt %, the effect of improving appearance quality may be insignificant. In contrast, if the amount of the polyamide exceeds 11 wt %, refractory performance may decrease.

The refractory composition may further include an additive, and the additive may include at least one of an antioxidant, a processing stabilizer, or an activator. The antioxidant may include a phenol-based antioxidant, an amine-based antioxidant, a sulfur-based antioxidant, a phosphorus-based antioxidant, etc., and examples thereof may include brand names such as Irganox, Irgafos, and Tinuvin series. The processing stabilizer may include an alcohol-based compound, a phthalate-based compound, a fluorine-based polymer, etc., and the alcohol-based compound may include polyvinyl alcohol, polyethylene glycol, polypropylene glycol, a C10-C25 aliphatic alcohol, etc.

The amount of the additive may be 0.5 wt % to 2 wt % based on the total weight of the composition. When the amount of additive added falls in the above range, the processability and appearance quality of the molded article may be further improved.

### Molded Article

A molded article according to some embodiments of the present disclosure may be produced by molding the refractory composition described above.

The molded article may be produced by a method including, for example, melting the refractory composition and extruding the molten composition or injection molding the same in a mold.

Also, the molded article may be produced by a method including, for example, melting the refractory composition, forming an extrudate by extruding the molten composition, and injection molding the extrudate using an injection molding machine. As such, the injection molding machine may serve to melt and injection mold the extrudate.

The refractory composition may be extruded using an extruder, and the extruder may include a raw material transfer section, a mixing section, and a discharge section, which are sequentially connected. When the extruder is driven, the temperature of the transfer section or the mixing section may be 220° C. to 250° C. and may be applied without limitation so long as it falls in the temperature range in which the base resin (polyketone) has fluidity and is not thermally decomposed.

The molded article may be applied to a member of a heating device, and the heating device may be a device that may cause heat generation at 1,000° C. or higher due to thermal instability. The heating device may be applied to, for example, lithium secondary batteries, fuel cells, thermo-electric devices, power conversion devices, internal combustion engines, etc., and may be applied to energy storage devices such as lithium secondary batteries.

The molded article may be, for example, a housing (finishing material), and the housing may include therein at least one of a battery module or a battery pack.

The impact strength of the molded article according to ISO 180 may be 6 kJ/m² to 12 kJ/m².

The PLC grade of the comparative tracking index of the molded article according to ASTM D3638 may be 0.

The flame retardancy of the molded article according to UL94 may be V-0 grade.

The surface of a test specimen having a predetermined area manufactured from the molded article may be breached at 10 cycles or more and the surface of the test specimen may not be breached at 8 cycles or less in the following UL 2596 Torch and Grit test (Hyundai MS940-02).

### [UL 2596 Torch and Grit Test]

A molded article is manufactured into a test specimen with an area of 200 mm×200 mm and a thickness of 2 mm, and the test specimen is subjected to cycles each including flame at 1,200° C. for 15 seconds at a distance of 60 mm from the surface thereof followed by flame at 1,200° C. and grit (particles) with an average diameter of 120 μm for 5 seconds at a speed of 0.6 g/s to evaluate the number of cycles when the surface of the test specimen is breached.

### Energy Storage Device

An energy storage device according to some embodiments of the present disclosure may include a housing manufactured by melting and injection molding the refractory composition and at least one of a battery cell or a battery module disposed in the housing.

The battery cell may typically include a cathode material, an anode material, and a conductive material in contact with the electrode materials and may include a separator and an electrolyte solution or a solid electrolyte interposed between the spaced electrode materials.

The battery cell may have a cylindrical shape, a prismatic shape, a pouch shape, etc.

The battery module may include a plurality of battery cells and may also include a controller configured to manage heat or stability of the battery cells.

A better understanding of the present disclosure may be obtained through the following examples and comparative examples. However, these examples are not to be construed as limiting the technical spirit of the present disclosure.

### Example 1

A composition having the following components in amounts (wt %) was prepared.
(A1) 35 wt % of a polyketone base resin having a melt flow rate of 200 g/10 min at 240° C. under a load of 2.16 kg according to ASTM D1238;
(B1) 50 wt % of glass fiber having a cross-sectional diameter of 10 μm and a length of 8 mm;
(B2) 3 wt % of silica having an average particle size of 30 μm and a cristobalite crystal structure
(B3) 3 wt % of a low-molecular-weight (Mw: 5,000) silicone resin;
(B4) 3 wt % of alumina having an average particle size of 30 μm;
(C) 5 wt % of melamine polyphosphate as a flame retardant;
(D) 1 wt % of an additive, the additive including a phenol-based antioxidant (Irganox 1098), a phosphorus-based antioxidant (PEP-36), and a processing stabilizer (E-Wax, cetostearyl alcohol, polysorbate) in a weight ratio of 1:1:1.

The composition was melt-kneaded using a twin-screw extruder to produce an extrudate in the form of a pellet. As such, the temperature of the raw material transfer section of the extruder was 230-240° C., the temperature of the mixing section was 230-240° C., the temperature of the discharge section was 240° C., and the RPM of the extrusion screw was 200.

The pellet extrudate thus manufactured was dried in an oven at 60° C., and the pellet extrudate was produced into an injection-molded article using an injection molding machine.

### Examples 2-4 and Comparative Examples 1-7

Respective injection molded articles were produced by preparing compositions having the components in amounts (wt %) shown in Tables 1 and 2 below, instead of the composition of Example 1, and then performing the same molding process as in Example 1.
(A2) Polyamide 6
(A3) Polypropylene having a melt flow rate of 50 g/10 min at 230° C. under a load of 2.16 kg according to ASTM D1238.

TABLE 1

| Classification | Example 1 | Example 2 | Example 3 | Example 4 |
|---|---|---|---|---|
| A1 polyketone | 35 | 30 | 25 | 28 |
| A2 polyamide | — | 5 | 10 | 5 |
| B1 glass fiber | 50 | 50 | 50 | 55 |
| B2 silica | 3 | 3 | 3 | 2 |
| B3 silicone | 3 | 3 | 3 | 2 |
| B4 alumina | 3 | 3 | 3 | 2 |
| C flame retardant | 5 | 5 | 5 | 5 |
| D additive | 1 | 1 | 1 | 1 |

Unit: wt %

TABLE 2

| | Comparative | Comparative | Comparative | Comparative | Comparative | Comparative | Comparative |
|---|---|---|---|---|---|---|---|
| Classification | Example 1 | Example 2 | Example 3 | Example 4 | Example 5 | Example 6 | Example 7 |
| A1 | 0 | 0 | 0 | 5 | 10 | 79 | 64 |
| polyketone | | | | | | | |
| A2 | 0 | 0 | 49 | 30 | 25 | 0 | 0 |
| polyamide | | | | | | | |
| A3 | 69 | 49 | 0 | 0 | 0 | 0 | 0 |
| polypropylene | | | | | | | |
| B1 glass | 30 | 30 | 30 | 50 | 50 | 15 | 30 |
| fiber | | | | | | | |
| B2 silica | 0 | 0 | 0 | 3 | 3 | 0 | 0 |
| B3 silicone | 0 | 0 | 0 | 3 | 3 | 0 | 0 |
| B4 alumina | 0 | 0 | 0 | 3 | 3 | 0 | 0 |
| C flame | 0 | 20 | 20 | 5 | 5 | 5 | 5 |
| retardant | | | | | | | |
| D additive | 1 | 1 | 1 | 1 | 1 | 1 | 1 |

Unit: wt %

### Test Example—Measurement of Properties

The properties of the molded articles produced in Examples and Comparative Examples were measured by the following methods, and the results thereof are shown in Tables 3 and 4 below.

### 1) Melt Flow Rate

According to ASTM D1238, measurement was performed under conditions of 240° C. and 2.16 kg. When the component with the highest amount in the base resin was polypropylene or polyamide, measurement was performed under conditions of 230° C. and 2.16 kg.

### 2) Impact Strength

Measurement was performed according to ISO 180.

### 3) Comparative Tracking Index (CTI)

Measurement was performed according to ASTM D3638, and PLC grades (0-5) are shown.

### 4) Appearance Quality

The surface appearance of the molded article (test specimen) was observed using a microscope at 1000× magnification and judged as excellent, good, or poor.

### 5) Flame Retardancy

Measurement was performed according to the UL94 test method.

### 6) Torch and Grit

According to UL 2596 (Hyundai MS940-02), the molded article was manufactured into a test specimen with an area of 200 mm×200 mm and a thickness of 2 mm, and the test specimen was subjected to cycles each including flame at 1,200° C. for 15 seconds at a distance of 60 mm from the surface thereof followed by flame at 1,200° C. and grit (particles) with an average diameter of 120 μm for 5 seconds at a speed of 0.6 g/s to evaluate the number of cycles when the surface of the test specimen is breached.

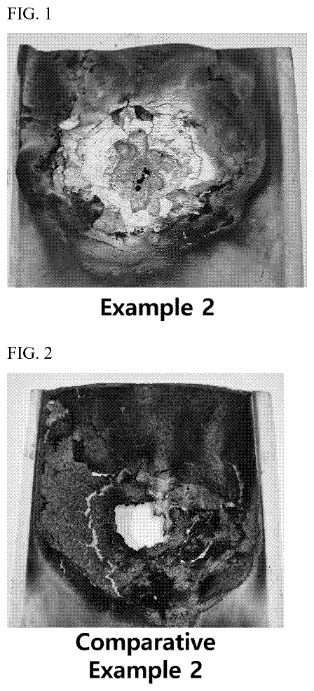

Example 2 and Comparative Example 2 were photographed after the test, and the comparison results thereof are shown in FIG. 1, FIG. 2 and Table 5 below.

TABLE 3

| Classification | Example 1 | Example 2 | Example 3 | Example 4 |
|---|---|---|---|---|
| Melt flow rate | 57 | 59 | 63 | 56 |
| (g/10 min) | | | | |
| Impact strength (kJ/m²) | 7.1 | 7.5 | 6.8 | 6.5 |
| Comparative tracking | 0 | 0 | 0 | 0 |
| index (PLC) | | | | |
| Appearance quality | Poor | Good | Good | Good |
| Flame retardancy | V-0 | V-0 | V-0 | V-0 |
| Torch and Grit | 10 | 10 | 10 | 10 |

TABLE 4

| | Comparative | Comparative | Comparative | Comparative | Comparative | Comparative | Comparative |
|---|---|---|---|---|---|---|---|
| Classification | Example 1 | Example 2 | Example 3 | Example 4 | Example 5 | Example 6 | Example 7 |
| Melt flow | 25 | 22 | 20 | 42 | 44 | 94 | 81 |
| rate | | | | | | | |
| (g/10 min) | | | | | | | |
| Impact | 8.6 | 7.7 | 9.1 | 7.2 | 7.4 | 6.2 | 6.8 |
| strength | | | | | | | |
| (kJ/m²) | | | | | | | |
| Comparative | 1 | 1 | 0 | 0 | 0 | 0 | 0 |
| tracking | | | | | | | |
| index | | | | | | | |
| (PLC) | | | | | | | |
| Appearance | Excellent | Excellent | Excellent | Good | Good | Good | Poor |
| quality | | | | | | | |
| Flame | HB | V-0 | V-0 | V-0 | V-0 | V-0 | V-0 |
| retardancy | | | | | | | |
| Torch and | 1 | 2 | 2 | 4 | 4 | 5 | 8 |
| Grit | | | | | | | |

TABLE 5

| | | Comparative |
|---|---|---|
| Classification | Example 2 | Example 2 |
| Number of cycles in Torch | 10 | 2 |
| and Grit test | | |
| Flame and smoke generation | Low | High |
| Test specimen deformation | Small | Large |
| Strength after durability test | High | Crumbling |
| Electrical insulating | Superior electrical | Electrical |
| properties (~600 V) | insulating properties | conduction |
| Others | Less swelling on the | Severe |
| | back of test specimen | deformation of |
| | Stabilization of torch | test specimen |
| | contact surface | |

Referring thereto, Comparative Examples 1 and 2, which included polypropylene as the main component of the base resin and in which polyketone was absent, showed very low durability after the Torch and Grit test, and the PLC grade of the comparative tracking index was relatively high, indicating reduced insulating properties.

Comparative Examples 3 to 5, which included polyamide as the main component of the base resin and in which polyketone was absent or the amount thereof was insufficient, showed somewhat reduced durability after the Torch and Grit test.

Comparative Examples 6 and 7, which included polyketone as the main component of the base resin but in which the amount thereof was excessive, showed reduced durability after the Torch and Grit test.

All Examples including the appropriate amount of polyketone, the fibrous filler, the particulate filler, the flame retardant, and the additive exhibited excellent durability after the Torch and Grit test, and Examples 2 to 4 further including the appropriate amount of polyamide also exhibited excellent appearance quality.

As is apparent from the foregoing, a refractory composition according to the present disclosure and application products thereof can delay the acceleration of thermal instability and impart fire resistance when thermal instability occurs in a heating device, a battery pack, etc.

In addition, the refractory composition according to the present disclosure and application products thereof can have good mechanical strength, flame retardancy, insulating properties, refractory performance, injection molding processability, and appearance quality.

The effects of the present disclosure are not limited to the foregoing. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described should be understood to be non-limiting and illustrative in every way.

What is claimed is:

1. A refractory composition comprising:
a base resin comprising polyketone in an amount from about 20 wt % to 55 wt % based on a total weight of the refractory composition;
a fibrous filler;
a non-fibrous filler; and
a flame retardant,
wherein the fibrous filler has a length/diameter ratio of greater than about 3.

2. The refractory composition of claim 1, wherein the refractory composition is applied to a member of a heating device.

3. The refractory composition of claim 1, wherein an amount of the fibrous filler is from about 30 wt % to 60 wt % based on a total weight of the composition.

4. The refractory composition of claim 1, wherein an amount of the non-fibrous filler is from about 6 wt % to 15 wt % based on a total weight of the composition.

5. The refractory composition of claim 1, wherein an amount of the flame retardant is from about 4 wt % to 20 wt % based on a total weight of the composition.

6. The refractory composition of claim 1, wherein the polyketone has a melt flow rate of 150 g/10 min to 400 g/10 min at 240° C. under a load of 2.16 kg in accordance with ASTM D1238.

7. The refractory composition of claim 1, wherein the fibrous filler comprises at least one of glass fiber, carbon fiber, basalt fiber and quartz fiber.

8. The refractory composition of claim 1, wherein the non-fibrous filler comprises at least one of silica, silicone, alumina, silicon carbide, boron carbide, silicon nitride, zirconia, titania, magnesia, aluminosilicate, calcium silicate and talc.

9. The refractory composition of claim 8, wherein the non-fibrous filler comprises silica, silicone and alumina.

10. The refractory composition of claim 9, wherein an amount of the silica is from about 2 wt % to 5 wt %, an amount of the silicone is from about 2 wt % to 5 wt %, and an amount of the alumina is from about 2 wt % to 5 wt %, based on a total weight of the composition.

11. The refractory composition of claim 1, wherein the flame retardant comprises at least one of triphenyl phosphate, trimethyl phosphate, triethyl phosphate, bisphenol diphenyl phosphate, ammonium polyphosphate, melamine polyphosphate, melamine pyrophosphate, melamine ammonium phosphate, melamine cyanurate, piperazine polyphosphate, xylenyl diphenyl phosphate, aluminum hydroxide and magnesium hydroxide.

12. The refractory composition of claim 1, further comprising from about 0.5 wt % to 2 wt % of an additive based on a total weight of the composition, wherein the additive comprises at least one of an antioxidant, a processing stabilizer, or an activator.

13. The refractory composition of claim 1, wherein the base resin further comprises polyamide, and an amount of the polyketone is from about 16 wt % to 44 wt % and an amount of the polyamide is from about 4 wt % to 11 wt % based on a total weight of the composition.

14. A molded article produced by molding the refractory composition of claim 1.

15. The molded article of claim 14, wherein a surface of a test specimen having a predetermined area is breached at 10 cycles or more in a UL 2596 Torch and Grit test below:
[UL 2596 Torch and Grit Test]
A molded article is manufactured into a test specimen with an area of 200 mm×200 mm and a thickness of 2 mm, and the test specimen is subjected to cycles each including flame at 1,200° C. for 15 seconds at a distance of 60 mm from a surface thereof followed by flame at 1,200° C. and grit (particles) with an average diameter of 120 μm for 5 seconds at a speed of 0.6 g/s to evaluate a number of cycles when the surface of the test specimen is breached.

16. An energy storage device, comprising:
a housing manufactured by melting and injection molding the refractory composition of claim 1; and
at least one of a battery cell or a battery module disposed in the housing.

17. A refractory composition comprising:
a base resin comprising polyketones in an amount from about 20 wt % to 55 wt %, said polyketones having a melt flow rate of 150 g/10 min to 400 g/10 min at 240° C. under a load of 2.16 kg in accordance with ASTM D1238;
a fibrous filler in an amount from about 30 wt % to 60 wt %, said fibrous filler having a length-to-diameter ratio greater than 3;
a non-fibrous filler in an amount from about 6 wt % to about 15 wt %; and
a flame retardant in an amount from about 4 wt % to 20 wt %.

18. The refractory composition of claim 17, further comprising one or more additives in a total amount from about 0.5 wt % to 2 wt %, wherein the one or more additives are selected from the group consisting of antioxidants, processing, stabilizers and activators.

19. The refractory composition of claim 17, wherein the non-fibrous filler comprises silica, silicone, and alumina, each in an amount of from about 2 wt % to 5 wt %, based on a total weight of the composition.

20. The refractory composition of claim 17, wherein the base resin further comprises polyamide, and
an amount of the polyketone is from about 16 wt % to 40 wt %, and
an amount of the polyamide is from about 4 wt % to 11 wt %,
each based on the total weight of the composition.
